(19) United States
(12) Patent Application Publication
(10) Pub. No.: US 2016/0201701 A1
(43) Pub. Date: Jul. 14, 2016

(54) Method for connecting the edges of surface components

(71) Applicants: LIYUAN WANG, Brookline, MA (US); MO-HAN HSIEH, Brookline, MA (US)

(72) Inventors: LIYUAN WANG, Brookline, MA (US); MO-HAN HSIEH, Brookline, MA (US)

(73) Assignees: MO-HAN HSIEH, Brookline, MA (US); LIYUAN WANG, Brookline, MA (US)

(21) Appl. No.: 14/591,920

(22) Filed: Jan. 8, 2015

(51) Int. Cl. F16B 5/00

(52) U.S. Cl. CPC F16B 5/00

(57) ABSTRACT

The invention is related to connecting the edges of surface components by joining the extension flap created from one edge and the buffer flap with opening slot created from the other edge. It comprises mathematical formulas to define the geometry of the flaps so that a connection of the edges of surface components can be accomplished.

### BACKGROUND OF THE INVENTION

Various connection methods for three-dimensional (3D) puzzles have been developed for years. Some adopt traditional tab and recess cut, others apply adhesives, and still others use different types of hinges to achieve the connection among puzzle pieces. This invention provides a new mechanism to connect two surface components that are most common in 3D puzzles.

### BRIEF DESCRIPTION OF THE DRAWINGS

Various embodiments of the invention are disclosed in the following detailed description and the accompanying drawings.

FIG. 1A illustrates an embodiment of two surface components (i.e. part 100 and part 200) with edge 102 and edge 202.

FIG. 1B extends from FIG. 1A and illustrates an embodiment of the buffer flap 104 with opening slot 106 created from edge 102, and the extension flap 204 created from edge 202. The opening slot 106 is created along the edge 102. The extension flap comprises of two folding lines (206 and 208). The areas extending from the folding lines to the edge of the flap are the tabs (210 and 212).

FIG. 2 illustrates the geometry of the extension flap and the buffer flap with opening slot.

FIG. 3A illustrates the original condition of part 100 and part 200 before connection.

FIG. 3B illustrates the folding of tab 210 and tab 212 before connection.

FIG. 3C illustrates the insertion of the extension flap 204 into the opening slot 106.

FIG. 3D illustrates the unfolding of tab 210 and tab 212 after connection.

### DETAILED DESCRIPTION

This invention provides a simple mechanism to connect the edges of surface components. The connection is achieved by first creating the extension flap from one edge and the buffer flap with opening slot from the other edge. The extension flap and the buffer flap with opening slot are then joined to connect the two edges.

The details of the invention are described below with figures that illustrate the geometry and the assembly process of the connection.

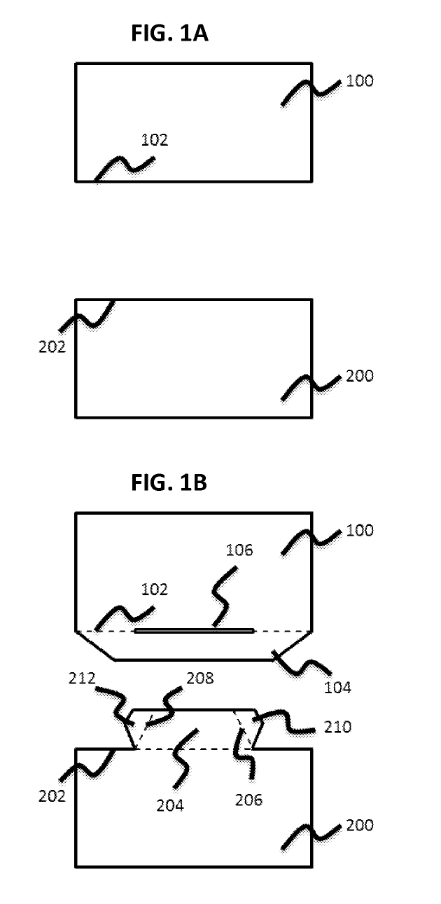

FIG. 1A illustrates an embodiment of two surface components (i.e. part 100 and part 200) with edge 102 and edge 202. To connect edge 102 and edge 202, the buffer flap with opening slot is created from edge 102, and the extension flap is created from edge 202. FIG. 1B extends from FIG. 1A and illustrates an embodiment of the buffer flap 104 with opening slot 106 created from edge 102, and the extension flap 204 created from edge 202. The opening slot 106 is created along edge 102. The extension flap comprises of two folding lines (206 and 208). The areas extending from the folding lines to the edge of the flap are the tabs (210 and 212).

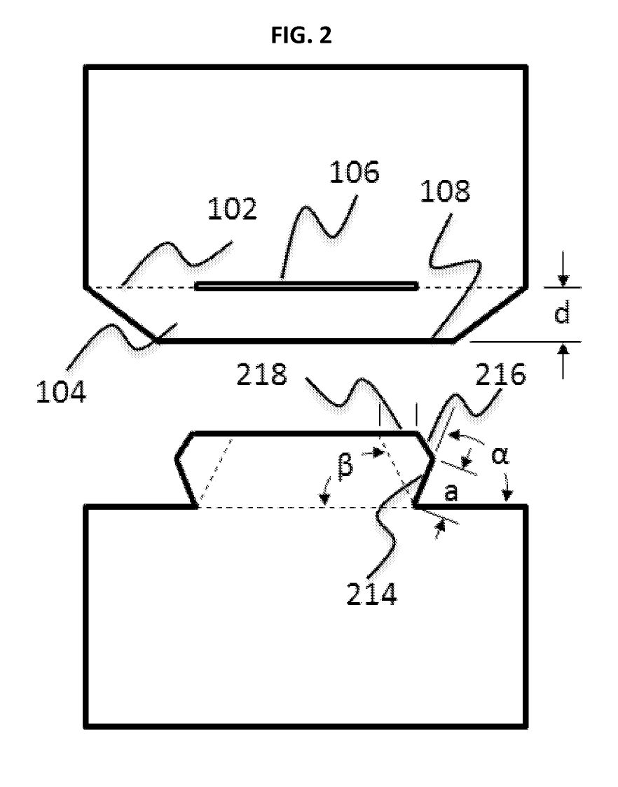

The geometry of the extension flap and that of the buffer flap with opening slot is defined in FIG. 2. The geometry of the flaps should be constrained by the following mathematic formulas to reliably perform their functions.
β≧½ (180°−α)
α<90°
a>0
d>0

As shown in FIG. 2, angle β defines the folding lines on the extension flap. Angle β has to follow the constraint of β≧½ (180°−α), where α is the leading angle of edge 214.

The major function of edge 214 in the extension flap is for creating the stoppage to prevent the extension flaps from slipping out of the opening slot. To perform this function, α has to be smaller than 90 degree, i.e. α<90°, and the length of edge 214 has to be at least larger than zero, i.e. a>0.

With the opening slot created along edge 102 of the original surface component, the function of the buffer flap 104 is to create an area for the opening slot 106 to reside in. As a result, the distance between the original edge 102 of the surface component and the leading edge 108 of the buffer flap has to be greater than zero, i.e. d>0.

As shown in FIG. 2, the area created by edge 214, edge 216, edge 218, and the folding line is defined as the tab. While edge 218 is an extension of the leading edge of the extension flap, edge 216 plays the role of cutting off the tip that would be formed by edge 214 and edge 218 so that the sturdiness of the tab can be increased.

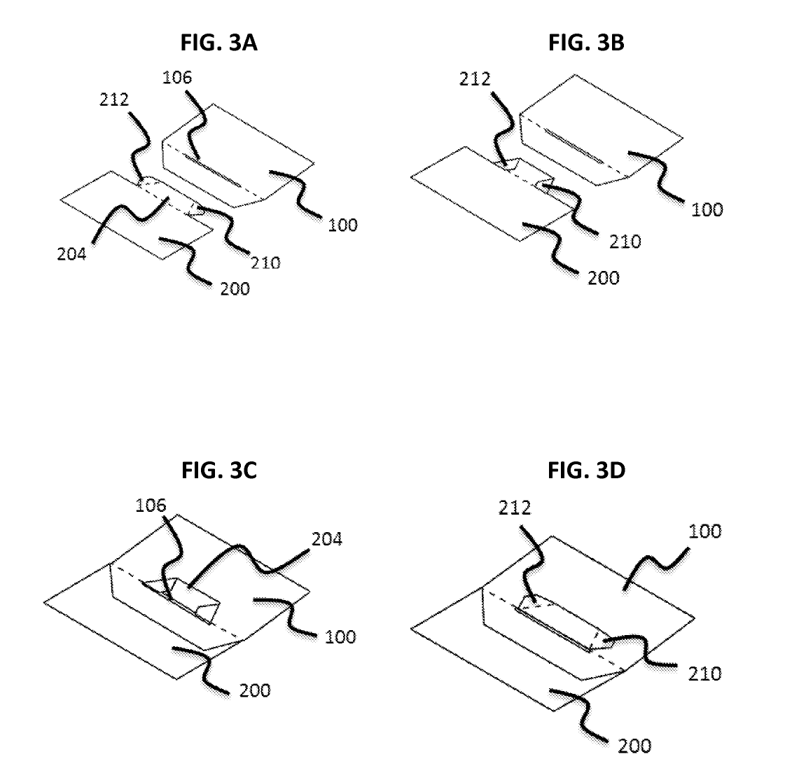

FIG. 3A to FIG. 3D demonstrate the assembly process of the extension flap and the buffer flap with opening slot. FIG. 3A illustrates the original condition of the two parts before connection. As shown in FIG. 3B, the two tabs (210 and 212) on the extension flap 204 are folded along the folding line before inserting into the opening slot 106. After folding the two tabs (210 and 212), FIG. 3C illustrates the insertion of the extension flap 204 into the opening slot 106. After inserting the extension flap 204 into the opening slot 106, FIG. 3D illustrates the unfolding of the two tabs (210 and 212) to create a stoppage to prevent the extension flap 204 from slipping out of the opening slot 106. Therefore, the connection between the two edges is formed.

We claim:

1. A method of connecting surface components by joining the extension flap(s) created from one edge and the buffer flap(s) with opening slot(s) created from the other edge.

2. A method as in claim 1, further comprises mathematical formulas to define the geometry of the extension flap and the buffer flap with opening slot for connecting surface components. The geometry of the extension flap and that of the buffer flap with opening slot is defined in FIG. 2. The geometry of the flaps should be constrained by the following mathematic formulas to reliably perform their functions.
β≧½ (180°−α)
α<90°
a>0
d>0

3. A method as in claim 2, wherein the tabs of the extension flap will be folded along the folding line before inserting into the opening slot. After inserting the extension flap into the opening slot, the folded tabs will be unfolded to create a stoppage to prevent the extension slot from slipping out of the opening slot. Therefore, the connection between the two edges is formed.

4. A method for constructing a three-dimensional object comprising of surface components. It comprises: (1) the geometry of the extension flap and the buffer flap with opening slot from claim 2, and (2) the process of connecting the two parts as described in claim 3.
